(19) United States
(12) Patent Application Publication
(10) Pub. No.: US 2026/0089272 A1
(43) Pub. Date: Mar. 26, 2026

(54) INFORMATION PROCESSING APPARATUS, METHOD FOR INFORMATION PROCESSING APPARATUS, AND STORAGE MEDIUM

(71) Applicant: CANON KABUSHIKI KAISHA, Tokyo (JP)

(72) Inventor: TETSU IMAI, Tokyo (JP)

(21) Appl. No.: 19/328,770

(22) Filed: Sep. 15, 2025

(30) Foreign Application Priority Data
Sep. 20, 2024 (JP) 2024-164405

(51) Int. Cl. H04N 1/00; G06F 3/12

(52) U.S. Cl. CPC H04N 1/00079; G06F 3/121; G06F 3/1234; G06F 3/1259; H04N 1/00037; H04N 1/00488; H04N 1/0049; H04N 2201/0094

(57) ABSTRACT

A method for an information processing apparatus includes sensing an occurrence of an error, performing notification of the occurrence of the error from among a plurality of error notification methods, and determining a method with which to perform error notification from among the plurality of error notification methods based on a content of the error.

### BACKGROUND

### Field of the Technology

The present disclosure relates to an information processing apparatus, a method for the information processing apparatus, and a storage medium.

### Description of the Related Art

When an error has occurred during use of an image formation apparatus, a user needs to be notified of the error and/or resolution information. A typical method is to provide an indication on a monitor of the image formation apparatus. However, a size of the monitor and the amount of information that can be displayed can vary depending on the different models of image formation apparatuses.

Large multi-function machines tend to have larger monitors that enable large amount(s) of information to be displayed. Small multi-function machines or ink-jet printers tend to have smaller monitor(s), which may only be able to display a small amount of information.

In the case of smaller image formation apparatuses, even when the user is notified that an error has occurred via monitor indication, there is a possibility that sufficient information may not be conveyed to the user. When the error is a minor error that can be explained using a minimal number of characters, no notification issues typically occur. In a case where a more substantial number of characters are needed to notify the user of, for example, a detailed error occurrence location and a method to resolve the error, some image formation apparatus models are not properly equipped to provide this information via monitor indication.

A general resolution method for smaller image formation apparatuses typically indicate only a title of the error or an error code on the monitor. The user can deal with this situation by, for example, relying on the indicated error title or error code to find a relevant section in the image formation apparatus'user manual, contacting a service engineer, or the like. These options can become burdensome to the user, as it is an inconvenience for a user to confirm the error.

Other resolution methods exist to notify the user of errors. For example, notification can occur via e-mail. Japanese Patent Laid-Open No. 06-048000 describes a configuration for printing out of a section of a user manual corresponding to the error that has occurred.

With the above-described resolution method, sufficient information can be provided to the user even when the error is complicated. When the user is notified of all errors by way of a specific option, an issue may occur. For example, in case of an error such as “scanner is temporarily busy”, the error may be resolved by performing an operation again in front of the image formation apparatus, and e-mail notification on the error of this type is not effective.

E-mail notification on “network error” is not to be performed via a network, and notification on “print unit error” is not to be performed by way of print output. By taking these into consideration, notification switch processing based on an error situation is needed. Japanese Patent Laid-Open No. 2010-147810 describes a configuration in which notification of an error is performed by a notification unit based on an error level (urgency).

Japanese Patent Laid-Open No. 2010-147810 is seen to discuss that an error notification unit is only switched based on the error level (urgency).

In a case, for example, where notification capacity (the amount of information that can be used for notification, a display size, a display color, and the like of a monitor) of the error notification unit is low for error content, error notification may not be appropriately performed. In a case where the user is to be notified of a malfunction of the error notification unit, when the malfunctioning error notification unit is selected as the notification unit, the error notification is not to be performed in the first place.

### SUMMARY

According to an aspect of the present disclosure, an information processing apparatus includes at least one memory and at least one processor, that when executing the program, is caused to sense an occurrence of an error, perform notification on the occurrence of the error from among a plurality of error notification methods, and determine a method with which to perform error notification from among the plurality of error notification methods based on a content of the error.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an overall configuration for carrying out the present disclosure.

FIG. 2 is a hardware configuration diagram of an image formation apparatus.

FIG. 3 is a block diagram illustrating a functional configuration of the image formation apparatus.

FIG. 4 is a flowchart of error notification determination processing in a first embodiment.

FIG. 5 illustrates error notification screen examples by way of monitor indication and error printing.

FIG. 6 is a flowchart of the error notification determination processing in a second embodiment.

FIG. 7 illustrates an example of an error notification priority order editing screen.

FIG. 8 is a flowchart of the error notification determination processing in a fourth embodiment.

FIG. 9 is a flowchart of the error notification determination processing in a fifth embodiment.

FIG. 10 illustrates an error notification screen example by way of e-mail notification.

FIG. 11 is a flowchart of the error notification determination processing in a sixth embodiment.

FIG. 12 illustrates an error screen example in a client terminal.

FIG. 13 illustrates an example of error notification priority orders.

FIG. 14 illustrates an example of error notification availability information.

FIG. 15 illustrates an example of error notification inhibition information.

FIG. 16 illustrates an example of error notification priority order editing information.

FIG. 17 illustrates an example of error notification priority orders after editing.

FIG. 18 illustrates an example of error notification non-recommendation information.

FIG. 19 illustrates an example of the error notification priority orders.

FIG. 20 illustrates an example of the error notification availability information.

FIG. 21 illustrates an example of the error notification priority.

FIG. 22 illustrates an example of job information.

FIG. 23 illustrates an example of error notification information.

### DESCRIPTION OF THE EMBODIMENTS

Hereinafter, embodiments for carrying out the present disclosure will be described with reference to the drawings. An information processing system of the present embodiment is applied to an image formation apparatus. Herein, a small apparatus including a small monitor with its screen being filled when a small number of characters are displayed is an example of the image formation apparatus.

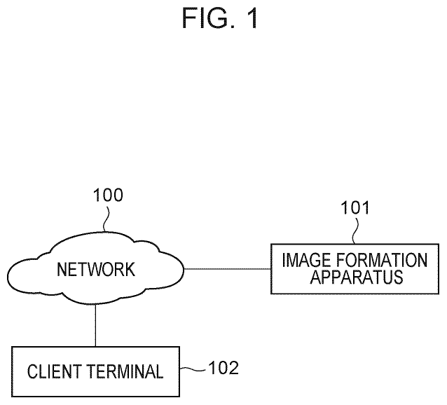

FIG. 1 illustrates an example of an overall configuration for carrying out the present disclosure. FIG. 1 illustrates an image formation apparatus 101. A client terminal 102 can send a job, such as printing, to the image formation apparatus and receive a result of a job, such as scanning or the like, executed by the image formation apparatus. The client terminal 102 can also send and receive e-mails. The image formation apparatus 101 and the client terminal 102 are connected via a network 100.

In a first to a fourth embodiment, the configuration of the image formation apparatus 101 can include the components illustrated in FIG. 1. In a fifth and a sixth embodiment, the configuration illustrated in FIG. 1, i.e., the configuration in which the image formation apparatus 101 and the client terminal 102 are connected via the network 100, is applicable.

### First Embodiment

According to a first embodiment, a configuration and processing of an information processing system executed on the image formation apparatus will be illustrated. When an error has occurred on the image formation apparatus, a reference is made to notification availability information associated with an error type.

Notification availability is determined following error notification priority orders that are separately managed, and error notification is performed by a notification method or a unit that performs notification.

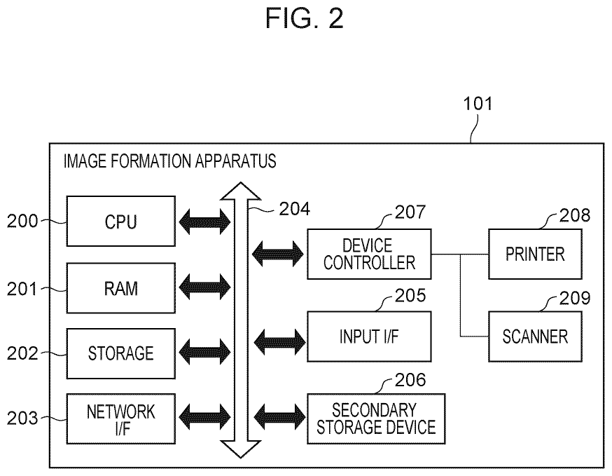

FIG. 2 illustrates a hardware configuration diagram of the image formation apparatus 101. The hardware configuration includes a central processing unit (CPU) 200, a random access memory (RAM) 201 as a temporary memory area, a storage 202, a network interface 203, a system bus 204, an input/output interface 205, a secondary storage device 206, a device controller 207, a printer 208, and a scanner 209.

The storage 202 stores an embedded program and data.

The network interface 203 is connected to a network to perform communication with a network device such as another computer or image formation apparatus. A communication method may be either wired or wireless. In addition, a mobile network interface may be included. The input/output interface 205 performs input or output of information or a signal via a touch panel, a button, a light emitting diode (LED) light, or the like.

The secondary storage device 206 is a secondary storage device represented by a hard disc drive (HDD) or a flash memory. The CPU 200 executes a program read from the RAM 201, the storage 202, the secondary storage device 206, or the like. The printer 208 and the scanner 209 execute print jobs and scan jobs respectively. The device controller 207 receives control commands from the CPU 200 and controls the printer 208 and the scanner 209.

The above-described hardware components are connected via the system bus 204. Unless otherwise described, in the present embodiment, the system bus 204 conveys the control commands from the CPU 200 to each of the hardware components connected to the system bus 204.

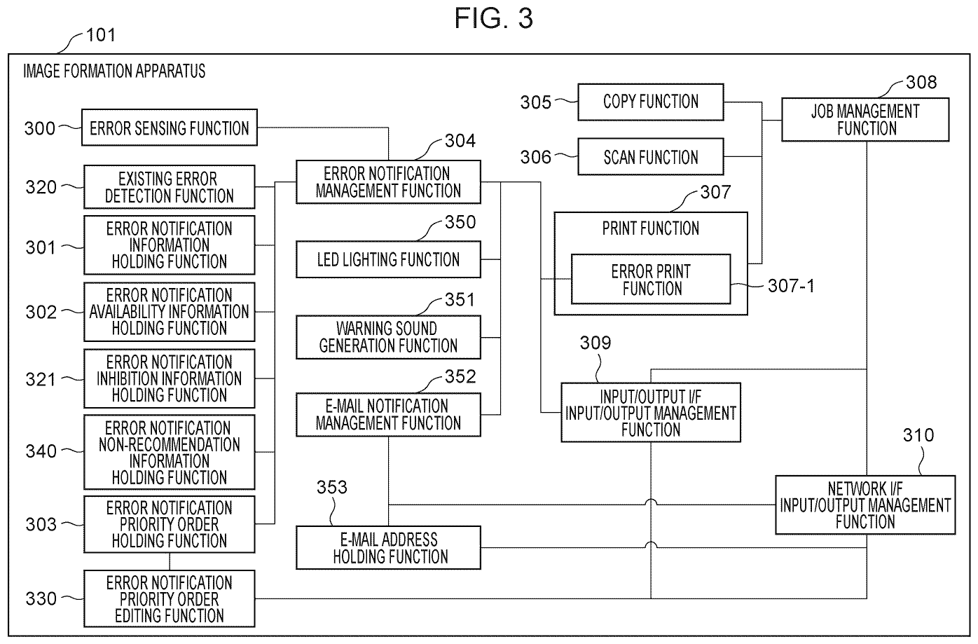

FIG. 3 is a block diagram illustrating an example of a functional configuration of the image formation apparatus. A program of the image formation apparatus is achieved when being read from the RAM 201, the storage 202, the secondary storage device 206, or the like and executed by the CPU 200. The input and the output via the monitor or the button are performed via the input/output interface 205. An access to the output via the network is performed via the network interface 203.

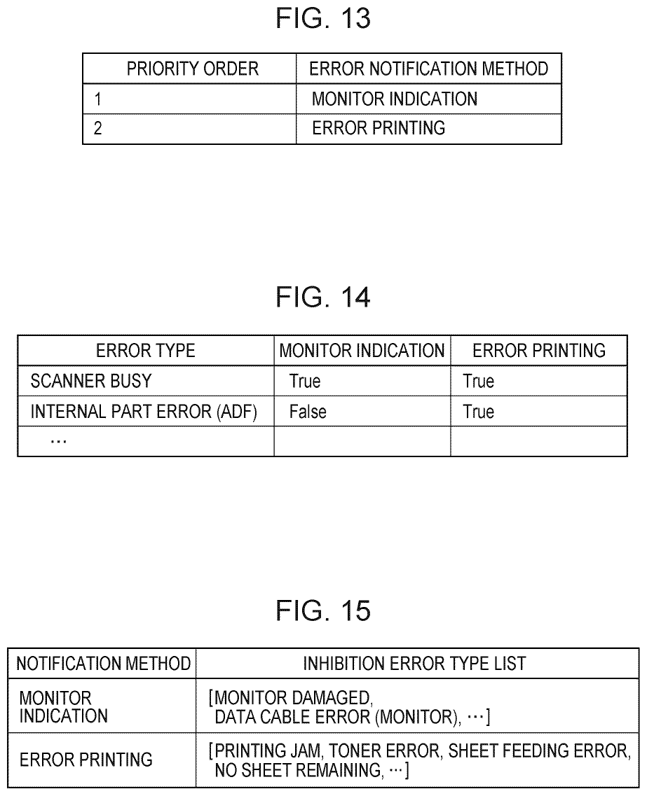

An error sensing function 300 is configured to sense an error that has occurred in the image formation apparatus 101 and to determine an error type. An error notification information holding function 301 stores notification information such as an error message. An error notification priority order holding function 303 stores priority orders of error notification methods. FIG. 13 illustrates an example of the error notification priority orders.

In the present embodiment, the image formation apparatus 101 attempts notification via monitor indication with a highest priority and attempts notification via error printing as an alternative option with a second highest priority. Notification methods of more than two types are typically switched, but according to the present embodiment, to simplify the explanation, the configuration is represented with two options.

An error notification availability information holding function 302 stores error notification availability information for each error type. FIG. 14 illustrates an example of the error notification availability information for each error type.

More specifically, FIG. 14 illustrates error notification availability information for a “scanner busy” error and an “internal part error (ADF)” error. For each error notification method, “True” indicates that notification can be performed and “False” indicates that notification is not to be performed.

The error of “scanner busy” is an error representing a state in which the scanner is currently processing a job, and scanning is temporarily not to be accepted. The image formation apparatus 101 can provide a message such as “retry because scanner is busy” to a user via monitor indication. An error notification can also be provided via error printing.

The “internal part error (ADF)” is an error representing a state in which an error has occurred in an internal part of an automatic document feeder (ADF) of the image formation apparatus 101. In this case, the image formation apparatus 101 indicates information on the specific error with the specific part, how a user should deal with the error, if a manufacturer support is needed, or the like. For this reason, the image formation apparatus sets that notification by way of monitor indication is not to be performed. Since the above-described information can be presented by way of error printing, the image formation apparatus sets that notification by way of error printing can be performed.

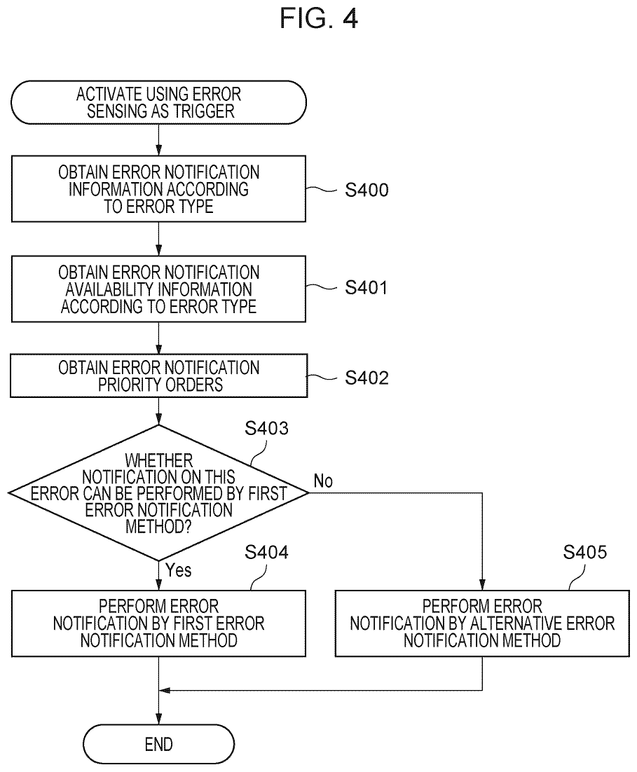

Returning to FIG. 3, the image formation apparatus 101 includes an error notification management function 304. The error notification management function 304 determines, based on content of an error sensed by the error sensing function 300, a specific error notification method from among a plurality of error notification methods. Specifically, the error notification management function 304 performs notification determination on the error sensed by the error sensing function 300 by using the error notification priority orders and the error notification availability information. Detailed error notification determination processing by the error notification management function 304 is illustrated in FIG. 4.

The image formation apparatus includes a copy function 305, a scan function 306, a print function 307, and a job management function 308. An input/output interface input/output management function 309 manages an input and an output of the input/output interface 205. A network interface input/output management function 310 manages an input and an output of the network interface 203.

The job management function 308 manages a job input via the input/output interface input/output management function 309 or the network interface input/output management function 310. An example of a job input via the input/output interface input/output management function 309 includes a scan job input via a monitor operation.

An example of a job input via the network interface input/output management function 310 includes a print job received from the client terminal 102. The job management function 308 manages execution of jobs by the copy function 305, the scan function 306, and the print function 307.

An error print function 307-1 is included in the print function 307. The error print function 307-1 is called from the error notification management function 304 to enable printing of error notification information. The input/output interface input/output management function 309 is called from the error notification management function 304 to enable monitor indication of the error notification information.

FIG. 4 is a flowchart illustrating the error notification determination processing executed by the error notification management function 304 according to the present embodiment. The error notification management function 304 starts the error notification determination processing by using the error sensing by the error sensing function 300 as a trigger. The error notification management function 304 obtains error notification information associated with the sensed error type from the error notification information holding function 301 (S400). The error notification management function 304 obtains error notification availability information associated with the sensed error type from the error notification availability information holding function 302 (S401).

The error notification management function 304 obtains error notification priority orders from the error notification priority order holding function 303 (S402). The error notification management function 304 determines, based on the error notification availability information, whether notification on the sensed error type can be performed by the error notification method with the highest priority in the error notification priority orders (S403).

FIG. 13 and FIG. 14 illustrate an example of a case where the error sensing function 300 has sensed an error.

In FIG. 13, the error notification method with the highest priority is monitor indication. When the error sensing function 300 senses a “scanner busy” error, the error notification management function 304 determines, based on the information illustrated in FIG. 14, that error notification by way of monitor indication can be performed (S403). When the error sensing function 300 senses an “internal part error (ADF)” error, the error notification management function 304 determines, based on the information illustrated in FIG. 14, that error notification by way of monitor indication is not to be performed (S403).

When it is determined that notification by the error notification method with the highest priority can be performed (S403: Yes), the error notification management function 304 performs error notification by the error notification method with the highest priority (S404).

When it is determined that notification by the error notification method with the highest priority is not to be performed (S403: No), the error notification management function 304 performs error notification via an alternative error notification method (error notification method with the second highest priority) (S405).

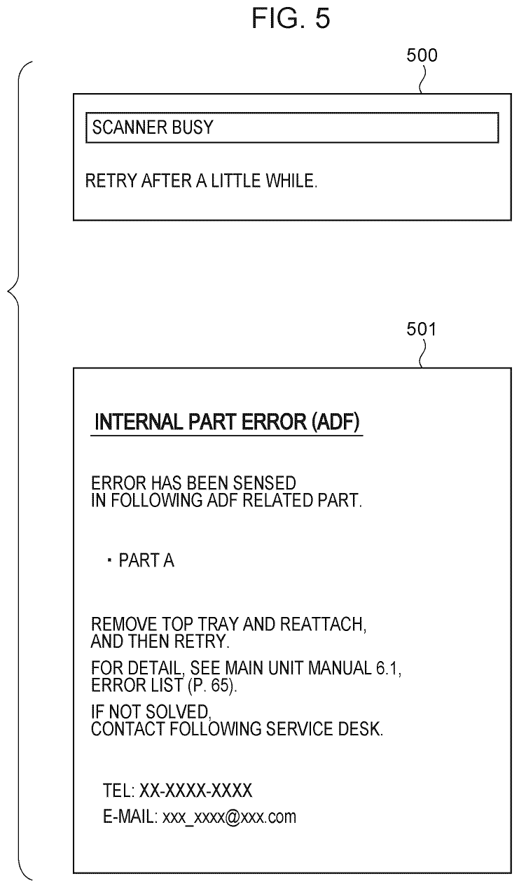

FIG. 5 illustrates examples of an error notification screen. More specifically, FIG. 5 illustrates an error notification example 500 via monitor indication when the “scanner busy” error occurs and an error notification example 501 via error printing when the “internal part error (ADF)”error occurs.

### Second Embodiment

A second embodiment will now be discussed. In the second embodiment, only differences from the first embodiment will be described.

The second embodiment illustrates an example of a configuration in which an error notification method is selected by taking into account influences by errors that previously occurred in the image formation apparatus 101. Thus, in addition to occurrences of errors that have been sensed, a list of existing errors that previously occurred is obtained. Thereafter, the notification availability based on the error type and whether the notification is inhibited by an existing error are determined, and then error notification is performed when the notification can be performed.

Returning to FIG. 3, an existing error detection function 320 obtains the list of existing errors that previously occurred in the image formation apparatus 101. An error notification inhibition information holding function 321 stores a list of error types that serve as factors to inhibit use of the error notification method for each error notification method. An example of the error notification inhibition information is illustrated in FIG. 15.

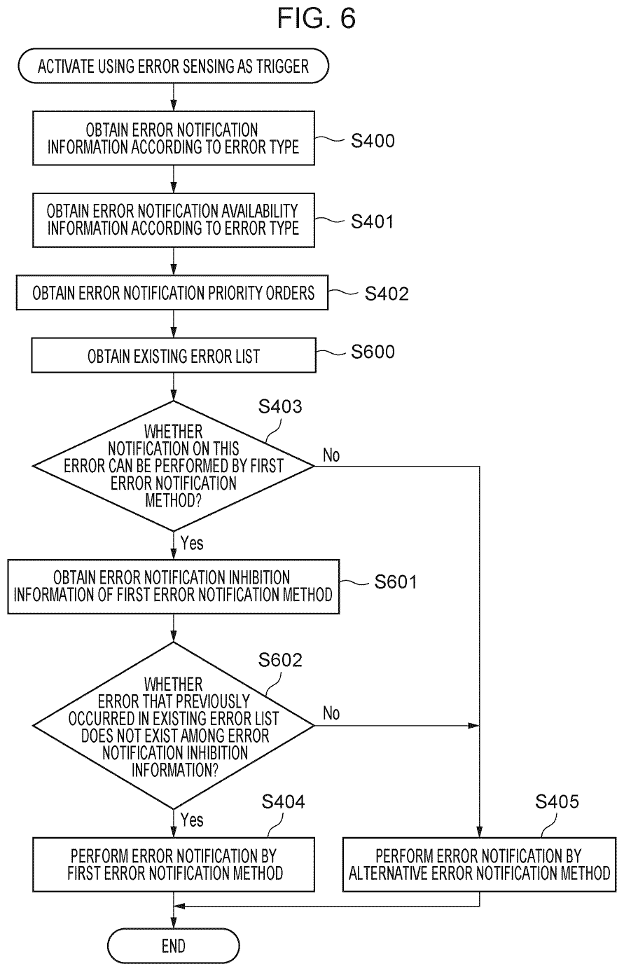

FIG. 6 is a flowchart of the error notification determination processing executed by the error notification management function 304 according to the present embodiment. After the processing in S402 in FIG. 4, the error notification management function 304 obtains the existing error list via the existing error detection function 320 (S600). When it is determined that notification can be performed by the error notification method with the highest priority (S403: Yes), the error notification management function 304 obtains error notification inhibition information of the error notification method with the highest priority from the error notification inhibition information holding function 321 (S601). The error notification management function 304 determines whether an error that previously occurred in the existing error list does not exist among the error notification inhibition information (S602).

A specific example will now be described with reference to FIG. 13 to FIG. 15. As previously described, in FIG. 13, the error notification method with the highest priority is monitor indication. It is presumed that the error sensing function 300 senses the “scanner busy” error and the existing error detection function 320 detects, for example, a monitor data cable error.

When the error notification management function 304 determines that error notification using monitor indication can be performed, the error notification management function 304 obtains inhibition information for error notification using monitor indication (second row in FIG. 15) from an error notification inhibition information holding function 321 (S601). The error notification management function 304 determines whether an error that previously occurred in the existing error list exists among the error notification inhibition information (second row in FIG. 15) (S602). As a result of the determination, an error of, for example, a monitor data cable error, which inhibits monitor indication notification, exists (S602: No).

In a case where an error that previously occurred in the existing error list does not exist among the error notification inhibition information (S602: Yes), the error notification management function 304 performs error notification by the error notification method with the highest priority (S404).

In a case where an error that previously occurred in the existing error list exists among the error notification inhibition information (S602: No), the error notification management function 304 performs error notification by an alternative error notification method (error notification method with the second highest priority) (S405).

### Third Embodiment

A third embodiment will now be discussed. In the third embodiment, only differences from the first and second embodiments will be described.

The third embodiment provides an example of a configuration in which the error notification priority orders illustrated in FIG. 13 can be designated by the user.

A configuration has been described in which the notification method is switched based on an error the occurrence of which has been sensed and an error that previously occurred. Priority orders of errors may vary depending on an environment or situation of the user. For example, a user with poor eyesight can prioritize printing output over monitor indication with hard-to-see letters.

In another example, a user who is not in the vicinity of an image formation apparatus can prioritize notification be provided on their client terminal 102.

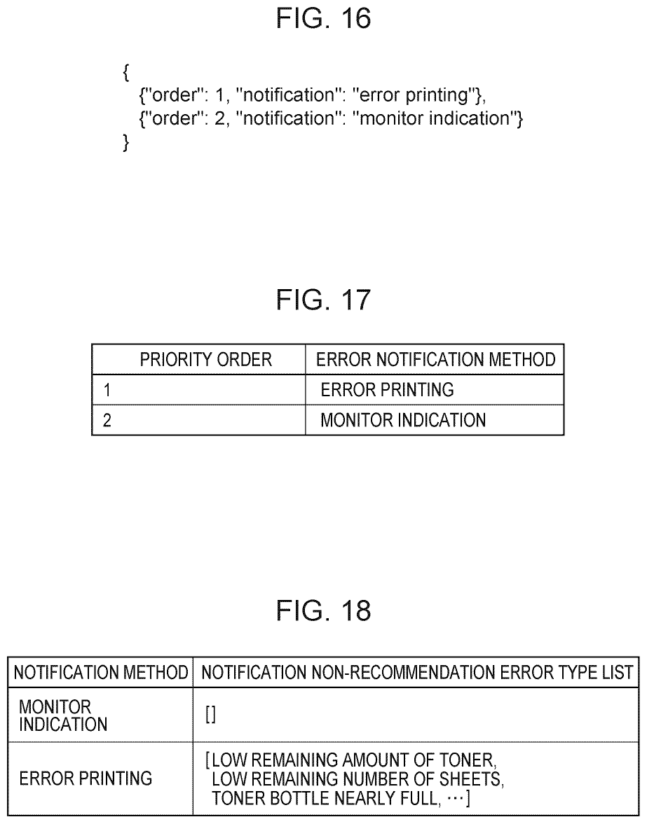

The image formation apparatus 101 includes an error notification priority order editing function 330. The error notification priority order editing function 330 enables editing the error notification priority orders stored by the error notification priority order holding function 303 based on error notification priority order editing information input via the input/output interface input/output management function 309. Examples of the error notification priority order editing information are illustrated in FIG. 16.

FIG. 17 illustrates error notification priority orders after the editing in the error notification priority order editing information of FIG. 16.

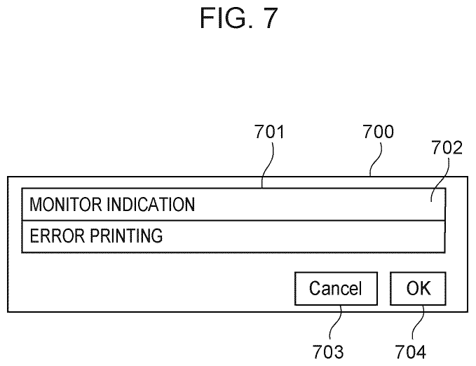

FIG. 7 illustrates an example of an error notification priority order editing screen displayed on the monitor of the image formation apparatus 101. More specifically, FIG. 7 illustrates an error notification priority order editing screen 700 and an error notification priority display 701. When an error notification priority order operation button 702 is pressed by the user, the error notification priority order display 701 can be edited. When a cancel button 703 is pressed by the user, information of the error notification priority order display 701 is rejected, and it is possible to return to a previous screen.

When an OK button 704 is pressed by the user, the information of the error notification priority order display 701 can be sent as the error notification priority order editing information. In a case where the user presses the OK button 704, the error notification priority order editing information is transferred from the input/output interface input/output management function 309 to the error notification priority order editing function 330 via the input/output interface 205. The error notification priority order editing function 330 enables the error notification priority orders stored by the error notification priority order holding function 303 to be edited by using the error notification priority order editing information.

### Fourth Embodiment

A fourth embodiment will now be discussed. In the fourth embodiment, only differences from the first to third embodiments will be described.

In the first to third embodiments, switching of the notification method is performed based on whether each error notification method can be used for an error type. Even if a specific notification unit can be used, an error can occur for which use of the specific notification unit is not appropriate. For example, “warning to inform that the remaining amount of consumable supplies is low”. While the content is a warning, the warning can be dealt with as one type of the errors the user is notified of on the system.

In another example, the remaining amount of consumable supplies for the image formation apparatus 101 can become low, while printing can still be performed, the image formation apparatus 101 can perform notification by way of error printing. The user may not want notification of a low remaining amount of consumable supplies to be provided via printing since that would result in further reduction of the consumable supplies. In this case, the image formation apparatus 101 would use a notification unit that avoided error printing.

The image formation apparatus 101 includes an error notification non-recommendation information holding function 340 that stores error notification non-recommendation information. The error notification non-recommendation information enables a list of error types to be managed in which, for a certain error notification method, notification by the notification unit is not recommended. FIG. 18 illustrates an example of the error notification non-recommendation information.

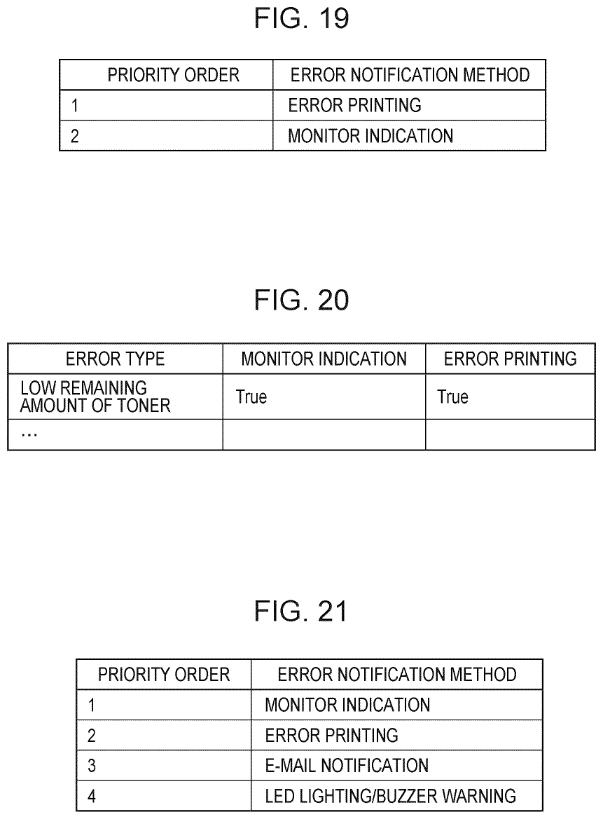

FIG. 19 illustrates an example of the error notification priority orders stored by the error notification priority order holding function 303 according to the present embodiment. For description simplicity, notification priority orders different from those of the first embodiment are set as the error notification priority orders.

FIG. 20 illustrates an example of the error notification availability information stored by the error notification availability information holding function 302 according to the present embodiment.

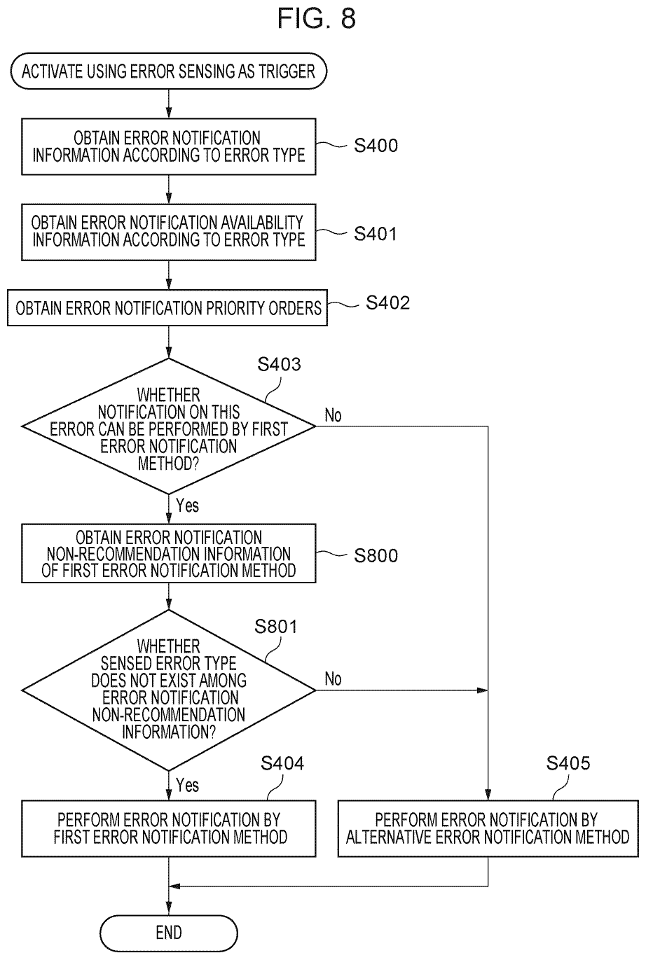

FIG. 8 is a flowchart of the error notification determination processing executed by the error notification management function 304 according to the present embodiment. When it is determined that notification can be performed by the error notification method with the highest priority (S403: Yes), the error notification management function 304 obtains error notification non-recommendation information of the error notification method with the highest priority from the error notification non-recommendation information holding function 340 (S800). The error notification management function 304 determines whether the sensed error type does not exist among the error notification non-recommendation information (S801).

FIG. 19 illustrates an example of the error notification priority orders according to the present embodiment. The error notification method with the highest priority is error printing. In the present example, the error sensing function 300 senses an error of low remaining amount of toner as illustrated in FIG. 20.

The error notification management function 304 determines, as illustrated in FIG. 20, that error notification by way of error printing can be performed (S403). The error notification management function 304 obtains, from the error notification non-recommendation information holding function 340, error notification non-recommendation information by way of error printing (third row in FIG. 18) (S800). The error notification management function 304 determines whether the sensed error of the low remaining amount of toner exists among the error notification non-recommendation information (third row in FIG. 18) (S801). As a result of the determination, the error printing non-recommendation error that is the error of the low remaining amount of toner exists (S801: No).

In a case where the sensed error type does not exist among the error notification non-recommendation information (S801: Yes), the error notification management function 304 performs error notification by the error notification method with the highest priority (S404). As illustrated in FIG. 19, the error notification management function 304 performs error notification by way of error printing.

In a case where the sensed error type exists among the error notification non-recommendation information (S801: No), the error notification management function 304 performs error notification by an alternative error notification method (error notification method with the second highest priority) (S405). As illustrated in FIG. 19, the error notification management function 304 performs error notification by way of monitor indication.

### Fifth Embodiment

A fifth embodiment will now be discussed. In the fifth embodiment, only differences from the first to fourth embodiments will be described.

The first to fourth embodiments discussed two types of error notification methods for discussion simplicity.

In the fifth embodiment, a configuration is described in which the image formation apparatus 101 switches three or more notification types. Specifically, the image formation apparatus 101 switches notification units by way of “e-mail notification” and “LED lighting (light emission)/buzzer warning (audio generation)” in addition to “monitor indication”and “error printing”of the first to fourth embodiments.

LED lighting function 350 enables an LED of the image formation apparatus 101 to be turned on. A warning sound generation function 351 enables generation of a warning sound by the image formation apparatus 101. An e-mail address holding function 353 enables storing of an e-mail address and notification destination management.

The e-mail address holding function 353 provides for an e-mail address input via the input/output interface input/output management function 309 or the network interface input/output management function 310 to be stored. An e-mail notification management function 352 enables an e-mail address and a notifying destination setting to be obtained from the e-mail address holding function 353, and e-mail notification can be performed via the network interface input/output management function 310.

The LED lighting function 350 is called from the error notification management function 304, so that notification on the occurrence of the error can be performed by way of LED lighting. The warning sound generation function 351 is called from the error notification management function 304, so that notification on the occurrence of the error can be performed by way of warning sound generation. The e-mail notification management function 352 is called from the error notification management function 304 so that notification on the error notification information can be performed by way of e-mail.

FIG. 21 illustrates an example of the error notification priority orders stored by the error notification priority order holding function 303 according to the present embodiment.

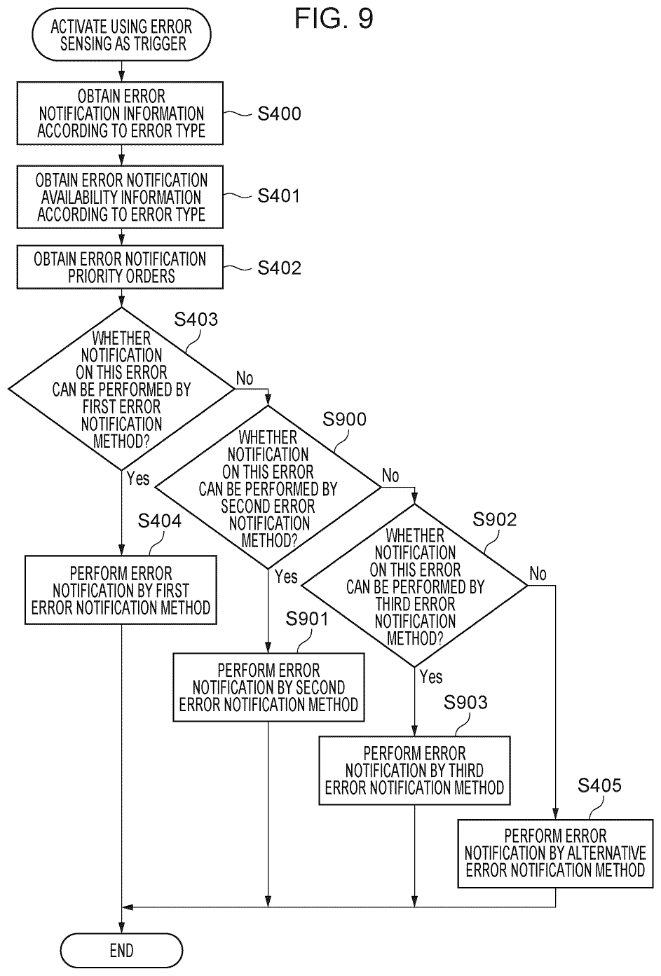

FIG. 9 is a flowchart of the error notification determination processing executed by the error notification management function 304 according to the present embodiment. When it is determined that notification by an error notification method with a highest priority is not to be performed (S403: No), the following processing is performed. That is, the error notification management function 304 determines, based on the error notification availability information obtained in S401, whether notification for the sensed error type can be performed by an error notification method with a second priority in the error notification priority orders (S900).

When it is determined that notification by way of monitor indication with the highest priority is not to be performed, the error notification management function 304 determines whether the error is an error enabling error printing notification with the second priority. When it is determined that notification can be performed by the error notification method with the second priority (S900: Yes), the error notification management function 304 performs notification by the error notification method with the second priority (S900) as illustrated in FIG. 21.

When it is determined that notification by the error notification method with the second priority is not to be performed (S900: No), the error notification management function 304 determines, based on the error notification availability information, whether notification for the sensed error type can be performed by an error notification method with a third priority in the error notification priority orders (S902).

When it is determined that notification by way of error printing with the second priority is not to be performed, the error notification management function 304 determines whether the error is an error enabling e-mail notification with the third priority. When it is determined that notification can be performed by the error notification method with the third priority (S902: Yes), the error notification management function 304 performs notification by the error notification method with the third priority (S903) as illustrated in FIG. 21.

When it is determined that notification by the error notification method with the third priority is not to be performed (S902: No), the error notification management function 304 performs error notification by an alternative error notification method (error notification method with a fourth priority) (S405). As illustrated in FIG. 21, the error notification management function 304 performs error notification by way of LED lighting/buzzer warning.

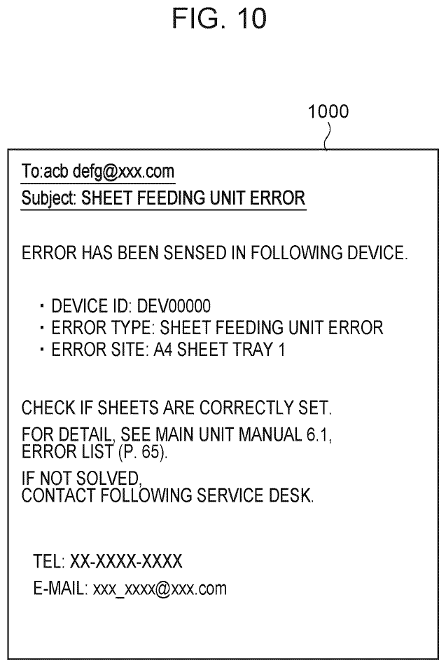

FIG. 10 illustrates an example of the error notification screen 1000 by way of e-mail notification.

### Sixth Embodiment

A sixth embodiment will now be discussed. In the sixth embodiment, only differences from the first to fifth embodiments will be described.

The first to fifth embodiments have described a configuration in which switching of notification in a case where an error has occurred in the image formation apparatus is performed. At this time, process content that has become an error occurrence cause in the image formation apparatus 101 is not used for the determination. In a case where an error has occurred in a job sent from the client terminal 102, for error notification, error content can be conveyed to the user in the form of a reply to the client terminal 102.

According to the sixth embodiment, when an error is sensed, a job currently being executed is obtained. In a case where the job currently being executed is sent from the client terminal 102, sending error information to the client terminal 102 is regarded as error notification having been performed.

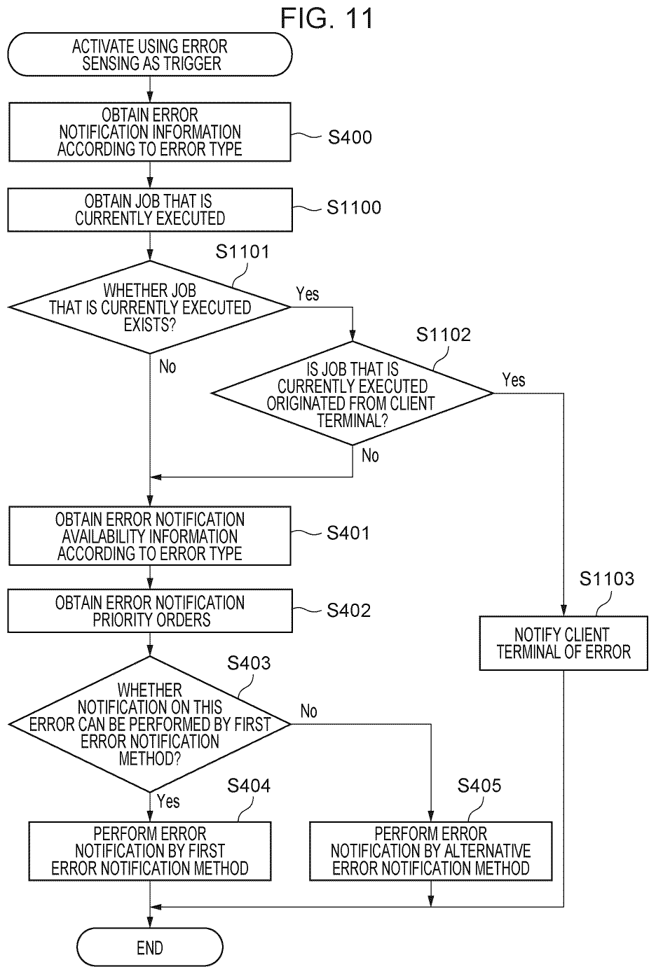

FIG. 11 is a flowchart of the error notification determination processing executed by the error notification management function 304 according to the present embodiment. After the error notification information is obtained (S400), the error notification management function 304 obtains the job currently being executed from the job management function 308 (S1100). The error notification management function 304 determines whether the job currently being executed exists (S1101). In a case where the job that is currently being executed does not exist (S1101: No), the error notification management function 304 proceeds to the processing in S401.

In a case where the job that is currently executed exists (S1101: Yes), the error notification management function 304 determines whether the job currently being executed is a job originated from the client terminal 102 (S1102). In a case where the job currently being executed is not a job originated from the client terminal 102 (S1102: No), the error notification management function 304 proceeds to the processing in S401.

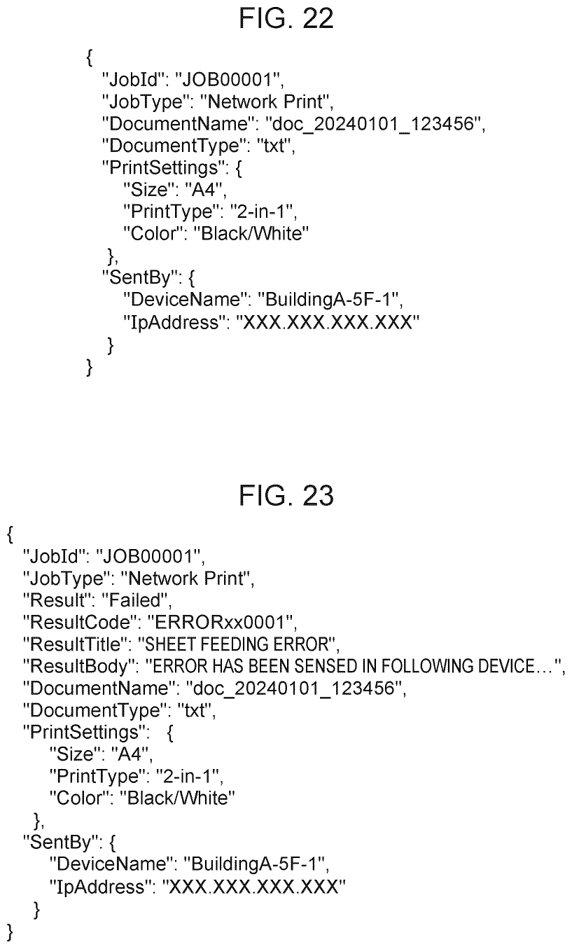

FIG. 22 illustrates an example of job information managed by the job management function 308. The following example represents a network print job originated from the client terminal 102. In the following example, since a “SentBy” attribute exists, the error notification management function 304 determines that the present job is sent from the client terminal 102.

In a case where the job currently being executed is a job originated from the client terminal 102 (S1102: Yes), the error notification management function 304 notifies the client terminal 102 of the error via the job management function 308 and the network interface input/output management function 310 (S1103). An example of error notification information sent by the job management function 308 is illustrated in FIG. 23.

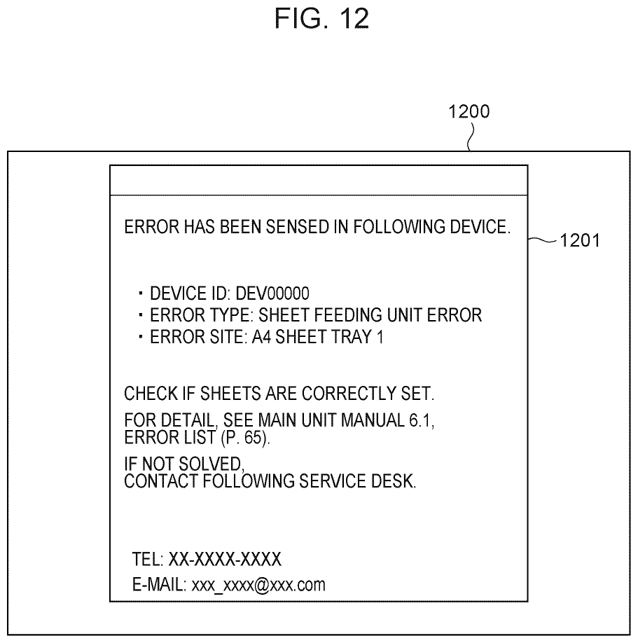

FIG. 12 illustrates an example of an error screen 1200 to be displayed on a screen of the client terminal 102. An error window 1201 is displayed on the error screen 1200.

### Other Embodiments

According to the above-described embodiments, priority orders are allocated when the error notification method is determined from among a plurality of error notification methods.

Various methods of allocating priority order are applicable. For example, a use environment and a way in which a user uses the image formation apparatus can be used to determine the priority orders.

For example, a monitor of an information processing apparatus is set as a first priority, while an e-mail sending unit is set as a second priority. A printing unit can be set as a third priority.

In a case where an error has occurred in a printer apparatus, such as a paper jam, since the user needs to directly access the printer apparatus, it is convenient to perform an error indication on a monitor of the printer apparatus. In this scenario, a monitor indication unit is set as the first priority. To suppress consumption of consumable supplies, such as print sheets, toner, or ink, a printing unit is set as a third priority while the e-mail sending unit is set as the second priority.

With respect to quiet environments, such as an office space, a notification unit using audio or light can be set as a lowered priority order.

In a case where an apparatus is installed in a busy and noisy location, such as a factory, error notification may be performed using audio, light, or the like.

To meet various demands that the user may have, the user can edit priority orders of the error notification methods.

In addition, in the printer apparatus, in the case of an error of the printing unit such as paper jam, when the printing unit is set as the error notification method, error notification is not to be performed. In view of the above, the error notification method may be determined based on the content (type) of the error to perform error notification. At least, in the case of an error of the notification unit, such error notification control may be performed that the error notification method excluding the notification unit in which this error is occurring is determined.

The present disclosure may be a control program for realizing one or more functions of the above-described embodiments and for causing a computer to execute the control program, as well as a storage medium storing the control program.

The present disclosure is not limited to the above-described embodiments, and various modifications based on the scope of the present disclosure are applicable. Configurations obtained by combining the above-described embodiments and any modified example(s) are included in the scope of the present disclosure.

According to the aspect of the present disclosure, when an error occurs in an image formation apparatus, notification can be performed by switching a unit based on the error type. Switching refers to switching based on whether each error notification method can be used for the current error type.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-164405, filed Sep. 20, 2024, which is hereby incorporated by reference herein in its entirety.

What is claimed is:

1. An information processing apparatus comprising:
at least one memory storing a program; and
at least one processor, that when executing the program, is caused to:
sense an occurrence of an error;
perform notification on the occurrence of the error from among a plurality of error notification methods; and
determine a method with which to perform error notification from among the plurality of error notification methods based on a content of the error.

2. The information processing apparatus according to claim 1, wherein
it is determined, based on a priority order of the error notification methods, the error notification method from among the plurality of error notification methods with which to perform the error notification.

3. The information processing apparatus according to claim 2, wherein
the information processing apparatus has a function of editing the priority order of the error notification methods.

4. The information processing apparatus according to claim 2, wherein
the error notification methods include monitor indication and printing, and
wherein the priority order for the monitor indication is set to a higher priority than the priority order for the error printing.

5. The information processing apparatus according to claim 2, wherein
the error notification methods include monitor indication and e-mail, and
wherein the priority order for the monitor indication is set to a higher priority than the priority order for the e-mail.

6. The information processing apparatus according to claim 2, wherein
the error notification methods include printing and e-mail, and
wherein the priority order for the e-mail is set to a higher priority order than the priority order for the printing.

7. The information processing apparatus according to claim 2, wherein
the error notification methods include monitor indication, e-mail, and printing, and
wherein the priority order for the monitor indication is set as a first priority, the priority order for the e-mail is set as a second priority, and the priority order for the printing is set as a third priority.

8. The information processing apparatus according to claim 7, wherein
the processor is further caused to provide error notification via a visual signal or an audible signal, and
wherein the priority order for the visual signal or the audible signal is set as a fourth priority.

9. The information processing apparatus according to claim 1, wherein
it is determined, based on information indicating notification availability that is determined by the content of the error, the error notification method from among the plurality of error notification methods with which to perform the error notification.

10. The information processing apparatus according to claim 1, wherein
the information processing apparatus manages a job received from a client terminal,
wherein the at least one processor is further configured to decide whether a job originated from the client terminal, and
wherein the information processing apparatus sends error notifications to the client terminal that transmitted the job.

11. A method for an information processing apparatus, the method comprising:
sensing an occurrence of an error;
performing notification of the occurrence of the error from among a plurality of error notification methods; and
determining a method with which to perform error notification from among the plurality of error notification methods based on a content of the error.

12. A non-transitory computer-readable storage medium for storing a program causing an information processing apparatus to execute a method, the method comprising:
sensing an occurrence of an error;
performing notification of the occurrence of the error from among a plurality of error notification methods; and
determining a method with which to perform error notification from among the plurality of error notification methods based on a content of the error.
